(19) United States
(12) Patent Application Publication
(10) Pub. No.: US 2026/0352733 A1
(43) Pub. Date: Nov. 5, 2026

(54) VEHICLE-TO-VEHICLE HANDSHAKE MECHANISM FOR MODEL SELECTION IN DISTRIBUTED FEDERATED LEARNING

(71) Applicants: FCA US LLC, Auburn Hills, MI (US); Stellantis Auto SAS, Poissy (FR)

(72) Inventor: Trevor Alexander Zeffiro, Auburn Hills, MI (US)

(21) Appl. No.: 19/195,087

(22) Filed: Apr. 30, 2025

(51) Int. Cl. H04L 67/12; G01R 31/392; H04L 9/40

(52) U.S. Cl. CPC H04L 67/12; G01R 31/392; H04L 63/061

(57) ABSTRACT

Distributed federated learning (DFL) systems and methods for a machine-learning model of original equipment manufacturer (OEM) vehicles involve a control system of a establishing a vehicle-to-vehicle (V2V) connection between first and second OEM vehicles and exchanging respective pluralities of weights for the model therebetween, executing, by the first and second OEM vehicles using respective local datasets, the model using both pluralities of weights to obtain two model outputs, calculating a distance metric between the two model outputs and, based on the calculated distance metric and a distance threshold, determining a consensus of the pluralities of weights to be used by the model in both the first and second OEM vehicles.

### FIELD

The present application generally relates to vehicle machine-learning models and, more particularly, to a vehicle-to-vehicle (V2V) handshake mechanism for model selection in distributed federated learning (DFL).

### BACKGROUND

Today's vehicles execute many trained machine-learning models (linear regression models, neural network models, etc.), such as for estimating parameters that are not directly or easily measurable. Non-limiting examples of such vehicle parameters include battery charge/health, vehicle train parameters (weight, drag, pitch, yaw, etc.), and autonomous or automated driver assistance (ADAS) system features. Historically, these models have been trained via centralized learning based on a large amount of collected training data (e.g., supplied by vehicles over time) and the centrally-trained models were thereafter loaded/updated to/at the vehicles. This often involved a large amount of data transmission, which is expensive, particularly when using cellular data networks. Accordingly, while such conventional vehicle model training and distribution systems do work for their intended purpose, there exists an opportunity for improvement in the relevant art.

### SUMMARY

According to one example aspect of the invention, a distributed federated learning (DFL) system for a model of original equipment manufacturer (OEM) vehicles including at least first and second OEM vehicles is presented. In one exemplary implementation, the DFL system comprises a transceiver of the first OEM vehicle that is configured to transmit and receive information via a set of communication networks, a memory of the first OEM vehicle that is configured to store the model, wherein the model is a machine-learning type model having a first plurality of weights associated therewith and is configured to generate an output based on a set of one or more inputs, and a control system of the first OEM vehicle that is configured to access the model from the memory, establish, via the transceiver and one of the set of communication networks, a vehicle-to-vehicle (V2V) connection with the second OEM vehicle, exchange, via the V2V connection, respective pluralities of weights for the model, including transmitting the first plurality of weights to and receiving a second plurality of weights from the second OEM vehicle, execute, using a local dataset, the model using both the first and second pluralities of weights to obtain two model outputs, calculate a distance metric between the two model outputs, and based on the calculated distance metric and a distance threshold, determine a consensus of the first and second pluralities of weights to be used by both the model in both the first and second OEM vehicles.

In some implementations, the control system is further configured to perform a threshold learning process to learn the distance threshold, wherein the threshold learning process involves the control system repeatedly receiving other pluralities of weights from other vehicles, executing the model using the first plurality of weights and the other pluralities of weights to obtain respective pairs of model outputs, and calculating the distance metrics between each pair of model outputs. In some implementations, the distance threshold is determined as a solution to the secretary problem. In some implementations, the control system is further configured to, after the threshold learning process is complete, perform a handshake procedure with the second OEM vehicle, wherein the handshake procedure involves a symmetric key exchange with an encryption scheme such that only accepted vehicles to a training group of OEM vehicles.

In some implementations, the training group of OEM vehicles include OEM vehicles that have previously had at least a certain number of previous V2V communication interactions and model weight exchanges with other OEM vehicles. In some implementations, the second OEM vehicle and the control system are each further configured to, after the handshake procedure, exchange losses of the model, using the first and second pluralities of weights, and using both the local dataset and another local dataset at the second OEM vehicle, and reporting a consensus of the first and second pluralities of weights corresponding to a lowest model loss. In some implementations, the model has been trained using an independent and identically distributed (IID) dataset, wherein the IID dataset is obtained from autoencoders trained per an architecture of the vehicle architecture in a federated manner to provide a latent space.

In some implementations, the model is configured to estimate a battery system state or health parameter of the first OEM vehicle. In some implementations, the model is configured to estimate a train parameter of the first OEM vehicle. In some implementations, the model and its output are utilized by an autonomous or advanced driver assistance (ADAS) system of the first OEM vehicle.

According to another example aspect of the invention, a DFL method for a model of OEM vehicles including at least first and second OEM vehicles is presented. In one exemplary implementation, the DFL method comprises accessing, by a control system of the first OEM vehicle and from a memory of the first OEM vehicle, the model, wherein the model is a machine-learning type model having a first plurality of weights associated therewith and is configured to generate an output based on a set of one or more inputs, establishing, by the control system and via a transceiver of the first OEM vehicle and one of a set of communication networks, a V2V connection with the second OEM, exchanging, by the control system and the second OEM vehicle via the V2V connection, pluralities of weights for the model, including transmitting the first plurality of weights to and receiving a second plurality of weights from the second OEM vehicle, executing, by the control system and using a local dataset, the model using both the first and second pluralities of weights to obtain two model outputs, calculating, by the control system, a distance metric between the two model outputs, and based on the calculated distance metric and a distance threshold, determining, by the control system, a consensus of the first and second pluralities of weights to be used by the model in both the first and second OEM vehicles.

In some implementations, the DFL method further comprises performing, by the control system, a threshold learning process to learn the distance threshold, wherein the threshold learning process involves the control system repeatedly receiving other pluralities of weights from other vehicles, executing the model using the first plurality of weights and the other pluralities of weights to obtain respective pairs of model outputs, and calculating the distance metrics between each pair of model outputs. In some implementations, the distance threshold is determined as a solution to the secretary problem. In some implementations, the DFL method further comprises, after the threshold learning process is complete, performing, by the control system, a handshake procedure with the second OEM vehicle, wherein the handshake procedure involves a symmetric key exchange with an encryption scheme such that only accepted vehicles to a training group of OEM vehicles.

In some implementations, the training group of OEM vehicles include OEM vehicles that have previously had at least a certain number of previous V2V communication interactions and model weight exchanges with other OEM vehicles. In some implementations, the DFL method further comprises, after the handshake procedure, exchanging, by the control system and the second OEM vehicle via the V2V connection, losses of the model, using the first and second pluralities of weights, and using both the local dataset and another local dataset at the second OEM vehicle, and reporting a consensus of the first and second pluralities of weights corresponding to a lowest model loss. In some implementations, the model has been trained using an IID dataset, wherein the IID dataset is obtained from autoencoders trained per an architecture of the vehicle architecture in a federated manner to provide a latent space.

In some implementations, the model is configured to estimate a battery system state or health parameter of the first OEM vehicle. In some implementations, the model is configured to estimate a train parameter of the first OEM vehicle. In some implementations, the model and its output are utilized by an autonomous or advanced driver assistance (ADAS) system of the first OEM vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an ad-hoc vehicle network illustrating a vehicle having an example distributed federated learning (DFL) system according to the principles of the present application;

FIG. 2 is a flow diagram of an example method for establishing vehicle-to-vehicle (V2V) communication for machine-learning model DFL according to the principles of the present application; and

FIG. 3 is a flow diagram of example V2V threshold learning and consensus determination methods for machine-learning model DFL according to the principles of the present application.

### DESCRIPTION

As previously discussed, today's vehicles execute many trained machine-learning models (linear regression models, neural network models, etc.), such as for estimating parameters that are not directly or easily measurable. Non-limiting examples of such vehicle parameters include battery charge/health, vehicle train parameters (weight, drag, pitch, yaw, etc.), and autonomous or automated driver assistance (ADAS) system features. Historically, these models were trained via centralized learning based on a large amount of collected training data (e.g., supplied by vehicles over time) and the centrally-trained models were thereafter loaded/updated to/at the vehicles. This often involved a large amount of data transmission, which is expensive, particularly when using cellular data networks. Thus, while these centralized learning systems do work for their intended purpose, an opportunity for improvement exists in the relevant art. Federated learning is another training or learning approach that is an alternative to centralized learning. In federated learning, the models are edge-trained (i.e., at the vehicles) and the trained models are uploaded to a central location for model aggregation and updating and redistribution thereafter. For example, in systems where high data volumes would be generated, such as high frequency data collection or a video-based system, a much smaller amount of data (the model) can be transmitted to the central system for processing and modification.

Federated learning therefore provides cost savings compared to centralized learning due to the smaller amounts of data transmitted via network(s). Federated learning also has other associated benefits, including increased data privacy as data does not not be transmitted from the edge (the vehicle) to the central location. As such, learning systems can learn patterns on sensitive data without having to export that data from the edge. Another benefit is easier or lesser data export limitations. For example, in the case where data needs to be transmitted across state or national borders, some governmental agencies attempt to limit the flow of export of sensitive information outside of their jurisdiction. To this end, by merely exporting the model, and not the underlying data, only the learnings from the data need be exported, and not the potentially sensitive data from which the leanings were extracted. Distributed federated learning (D-FL or DFL) is a specific federated learning approach that involves one additional concept. More specifically, instead of uploading the trained models to a central location, the trained models are instead distributed amongst a set of aggregation and processing nodes (other vehicles), which may then in turn upload their results to yet another higher order set of aggregation and processing nodes. The final result (a final trained model) is a final aggregation of all of these learnings to a single aggregation node.

Accordingly, improved DFL model training and distribution systems and methods are presented herein. These DFL model training and distribution techniques involving creating an ad-hoc network of vehicles, via both short and long range communication networks, and a unique vehicle-to-vehicle (V2V) handshake process and V2V model output comparison process. The initial handshake process involves only exchanging a symmetric key when the vehicle is a known member of a training cohort. After the handshake process, the vehicles exchange model weights and both vehicles run inference on both models using their own local data. The better performing model (e.g., having a lowest loss across both datasets) is selected by both vehicles, and the vehicles of the training group report their consensus along with the corresponding losses. Potential benefits included reduced data transmission costs, improved user data privacy (e.g., compared to centralized learning) and mitigated or eliminated security risks that are traditionally associated with inherent to DFL systems and methods via the utilization of an interaction threshold and handshake process.

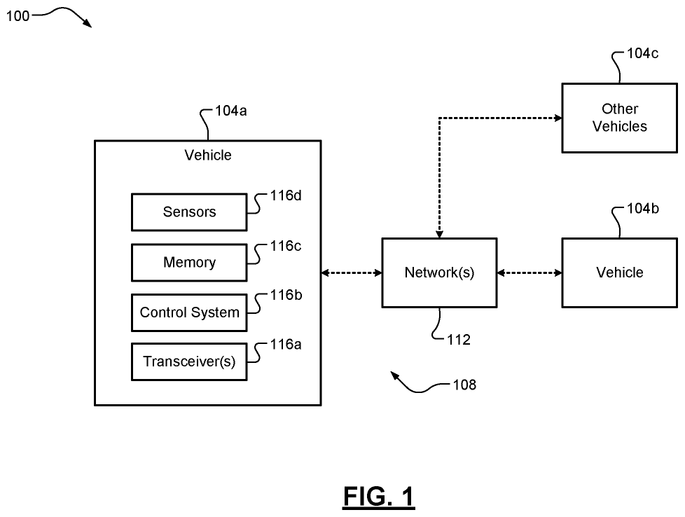

Referring now to FIG. 1, a functional block diagram of an ad-hoc vehicle network 100 illustrating a vehicle 104a having an example DFL system 108 according to the principles of the present application is illustrated. The ad-hoc vehicle network 100 (also “vehicle network 100” herein) comprises a plurality of vehicles 104a, 104b, and 104c (collectively “vehicles 104,” where vehicle 104c references “other vehicles” that are separate from two particular vehicles 104a and 104b that will be specifically referenced to describe V2V connections and interactions herein). The vehicles 104 can all be associated with a same original equipment manufacturer (OEM) (and also referred to as “OEM vehicle(s)” herein) and thus the models and other information shared amongst the vehicles 104 can generally be assumed to be trusted. The vehicles 104 can communicate with one another via one or more communication networks 112 (also “networks 112” herein). Non-limiting examples of the networks 112 include long-range communication networks (WiFi, cellular data networks, satellite data networks, etc.), short-range communication networks (DSRC, Bluetooth, WiFi direct, Zigbee, etc.), and combinations thereof. The vehicles 104 can also communicate with remote computing server(s) via the networks 112, such as remote computing server(s) or computing systems associated with the OEM.

Vehicle 104a is shown to include a communication system or transceiver 116a configured for communication via the networks 112, as well as a control system 116b, a memory 116c, and a set of one or more sensors 116d. It will be appreciated that these are merely a few example components of the vehicle 104a for purposes of describing the aspects of the present application and that the vehicle 104a can include many other systems that are not specifically illustrated (a powertrain, a driveline, etc.). The control system 116a is configured to execute a machine-learning model (also “model” herein), which could be stored at the memory 116c. The model can be any suitable type of model, including, but not limited to, linear regression models and neural network or tree-based models. Non-limiting examples of the models utilized by the vehicles 104 include battery state/health estimation models (e.g., for battery system(s) of each vehicle 104, which are not explicitly shown), vehicle train (e.g., drivetrain) parameter estimation models, and autonomous/ADAS models. As previously discussed, rather than being centrally trained and distributed to the vehicles 104, the models herein are edge-trained (i.e., at the vehicles 104) and their parameters (weights) are selectively adjusted or updated via the DFL system 108 and processes described herein. In one example embodiment, the selective updating or tuning of the model weights involves low-rank adaptation (LoRA), which involves efficiently fine-tuning machine-learning models without retraining the entire model.

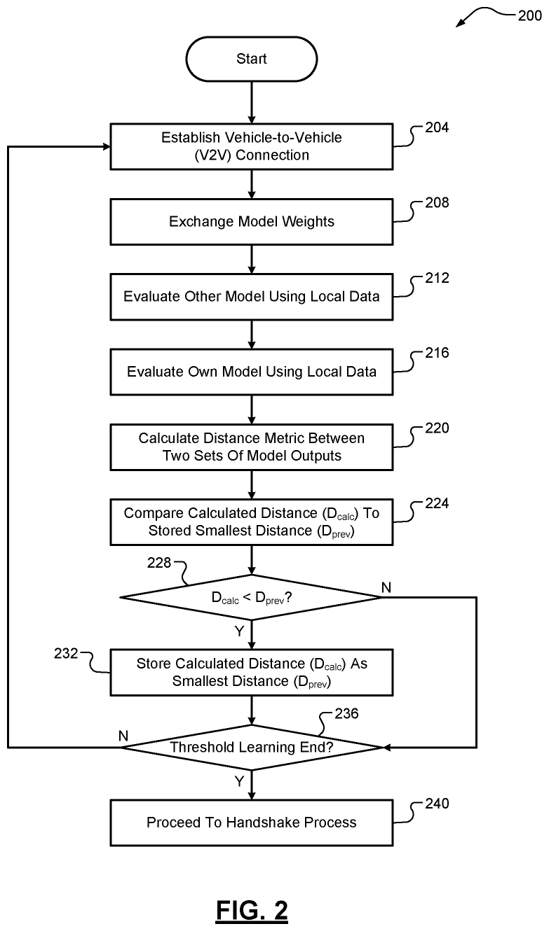

Referring now to FIG. 2 and with continued reference to FIG. 1, a flow diagram of an example method 200 for establishing V2V communication for machine-learning model DFL according to the principles of the present application is illustrated. While the method 200 specifically references the ad-hoc vehicle network 100 including vehicles 104a and 104b for descriptive/illustrative purposes, it will be appreciated that the method 200 could be applicable to any suitably configured vehicles having common machine-learning models and sufficient computing and communication capabilities. The method 200 begins at 204 where the vehicles 104a and 104b establish a V2V connection therebetween via the networks 112. In one example embodiment, this initial V2V connection establishment involves a symmetric key exchange (e.g. a Diffie-Hellman, or DH key exchange) with an encryption scheme such that only known members of the training cohort (i.e., the vehicles 104 of the OEM or a sub-set or sub-group of the vehicles 104 of the OEM) can decrypt the data discussed below. Upon establishing the V2V connection, the method 200 proceeds to 208 where the vehicles 104a and 104b exchange their current (stored) parameters for a particular model via the V2V connection through network(s) 112. While model weights are specifically described herein, it will be appreciated that alternative or additional parameters could be exchanged/shared. As previously discussed, the model can be a federated machine-learning model with a static set of input variables and output variables.

In one example embodiment, the model can be trained alongside an autoencoder to allow for the general case where the input variables are not identical with one another. This autoencoder does not need to be identical for all agents/nodes, and can be trained in a parallel federated learning session for agents with the same architecture. As such this method can be applied to predictions leveraging the latent space of an autoencoder, and in the simplest case, the identity function can be used for both the encoder and decoder. At 212, the vehicle 104a (i.e., its control system 116b) evaluates the other model (from vehicle 104b) using local data (e.g., obtained from its sensors 116d or other local systems). The local data should be independent and identically distributed (IID) data, which refers to each data point being drawn or obtained independently and from the same underlying probability distribution. Potential sources for this IID data include (i) autoencoders trained per vehicle architecture in a federated manner to provide a latent space that we assume is IID, (ii) the vehicles 104 producing the IID data (e.g., using respective sensors, such as sensors 116d) with respect to the models in question, or (iii) some other transform to convert stored or obtained non-IID data to IID data. At 216, the control system 116b evaluates its own model (e.g., stored at memory 116c) using the local data. At 220, the control system 116b calculates a distance metric between the two sets of model outputs.

This distance metric represents how well the two models produce or generate sufficiently similar results. At 224, the control system 116b compares the calculated distance (D_{calc}) to a stored (previous) smallest distance (Dₚᵣₑᵥ). At 228, the control system 116b determines whether the calculated distance D_{calc} is less than the stored smallest distance Dₚᵣₑᵥ. When false, the method 200 proceeds to 236. When true, the method 200 proceeds to 232 where the control system 116b stores the calculated distance D_{calc} as the stored smallest distance Dₚᵣₑᵥ (e.g., at memory 116c). At 236, the control system 116b determines whether the threshold learning procedure is complete and can end. In one example embodiment, this can involve comparing the stored smallest distance Dₚᵣₑᵥ (which may now be equivalent to the calculated distance D_{calc}) to a distance thresholds (D_{TH}). In one example embodiment, thresholds are dynamically set based on a solution to the secretary problem, where the optimal policy for the secretary problem is a stopping rule after a number of inputs (also known as the “best choice problem” and the “37% rule”). In another example embodiment, thresholds are set based on a predetermined or predefined static threshold value, which could be selected by a designer or engineer for the vehicles 104. When the stored smallest distance Dₚᵣₑᵥ satisfies a distance threshold D_{TH}, the method 200 proceeds to 240. Otherwise, the threshold learning procedure is not complete and the method 200 ends or returns to 204 for continued learning (e.g., via additional V2V communications and data exchanging). Finally, at 240, the method 200 can end and the vehicles 104 can proceed to the handshake process at 240.

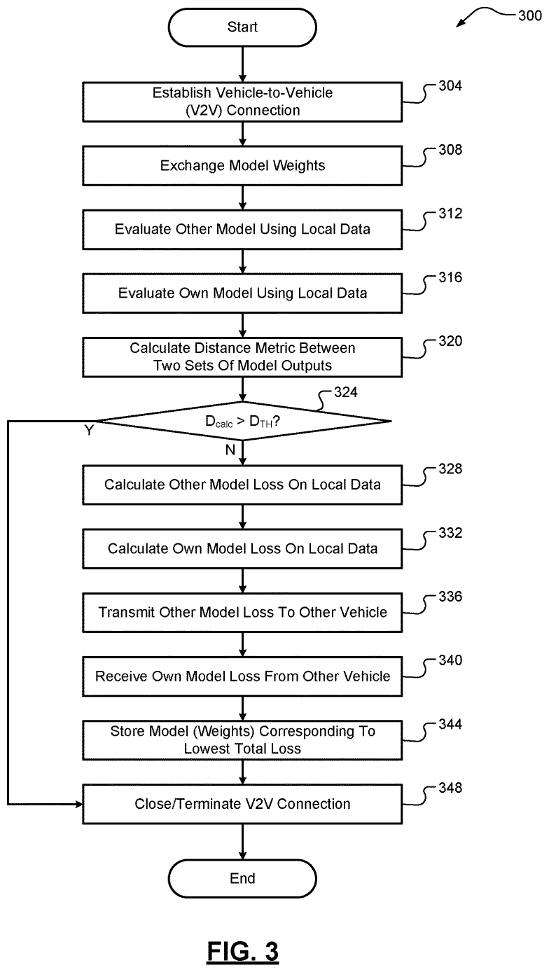

Referring now to FIG. 3 and with continued reference to the previous figures, a flow diagram of an example V2V consensus determination methods 300 for machine-learning model DFL according to the principles of the present application is illustrated. While the method 300 specifically references the ad-hoc vehicle network 100 including vehicles 104a and 104b for descriptive/illustrative purposes, it will be appreciated that the method 300 could be applicable to any suitably configured vehicles having common machine-learning models and sufficient computing and communication capabilities. The term “consensus” as used herein refers to a level of variance in output of the models deployed at the edge (vehicles 104) being below a certain threshold when similar or the same data is applied to multiple models (e.g., the same model having different parameters or weights at different vehicles 104). The method 300 could be executed, for example, after the threshold training procedure of method 200 of FIG. 2 has been completed and the handshake procedure at 240 has been completed. The method 300 begins at 304 where the vehicles 104a and 104b establish a V2V connection therebetween via the networks 112. In one example embodiment, this initial V2V connection establishment involves a symmetric key exchange (e.g. a DH key exchange) with an encryption scheme such that only known members of the training cohort can decrypt the data discussed below. Upon establishing the V2V connection, the method 300 proceeds to 308 where the vehicles 104a and 104b exchange their current (stored) parameters for a particular model via the V2V connection through network(s) 112. At 312, the vehicle 104a (i.e., its control system 116b) evaluates the other model (from vehicle 104b) using local data (e.g., obtained from its sensors 116d or other local systems).

At 316, the control system 116b evaluates its own model (e.g., stored at memory 116c) using the local data. At 320, the control system 116b calculates a distance metric D_{calc} between the two sets of model outputs. At 324, the control system 116b determines whether the calculated distance metric D_{calc} exceeds the distance threshold D_{TH} previously determined via the above-described threshold determination procedure. When true, the method 300 proceeds to 348. When false, the method 300 proceeds to 328. At 328, the control system 116b calculates the other model's loss on the local data (i.e., the loss of the model using the local data and the other plurality of weights). At 332, the control system 116b calculates its own model's loss on the local data (i.e., the loss of the model using the local data and the plurality of weights). At 336, the control system 116b transmits, via the V2V communication session (i.e., via the transceiver 116a and the network 112), the other model's calculated loss and at 336, the control system 116b also receives, from the other vehicle 104b, its mode's calculated loss (calculated by the other vehicle 104b using its model with the plurality of weights and its local dataset). At 344, the vehicles 104a and 104b determine a consensus best model as the one having the lower total losses and that consensus best model (i.e., the plurality of weights corresponding thereto) are selected as the consensus and stored for future usage. This consensus and the corresponding model losses (but not the local datasets) could also be reported to other entities, such as a central OEM computing server/system and/or to other vehicles 104 in the training group. At 348, the control system 116b terminates or ends the V2V communication session and the method 300 then ends.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A distributed federated learning (DFL) system for a model of original equipment manufacturer (OEM) vehicles including at least first and second OEM vehicles, the DFL system comprising:
a transceiver of the first OEM vehicle that is configured to transmit and receive information via a set of communication networks;
a memory of the first OEM vehicle that is configured to store the model, wherein the model is a machine-learning type model having a first plurality of weights associated therewith and is configured to generate an output based on a set of one or more inputs; and
a control system of the first OEM vehicle that is configured to:
access the model from the memory;
establish, via the transceiver and one of the set of communication networks, a vehicle-to-vehicle (V2V) connection with the second OEM vehicle;
exchange, via the V2V connection, respective pluralities of weights for the model, including transmitting the first plurality of weights to and receiving a second plurality of weights from the second OEM vehicle;
execute, using a local dataset, the model using both the first and second pluralities of weights to obtain two model outputs;
calculate a distance metric between the two model outputs; and
based on the calculated distance metric and a distance threshold, determine a consensus of the first and second pluralities of weights to be used by both the model in both the first and second OEM vehicles.

2. The DFL system of claim 1, wherein the control system is further configured to perform a threshold learning process to learn the distance threshold, wherein the threshold learning process involves the control system repeatedly receiving other pluralities of weights from other OEM vehicles, executing the model using the first plurality of weights and the other pluralities of weights to obtain respective pairs of model outputs, and calculating the distance metrics between each pair of model outputs.

3. The DFL system of claim 2, wherein the distance threshold is determined as a solution to the secretary problem.

4. The DFL system of claim 2, wherein the control system is further configured to, after the threshold learning process is complete, perform a handshake procedure with the second OEM vehicle, wherein the handshake procedure involves a symmetric key exchange with an encryption scheme such that only accepted vehicles to a training group of OEM vehicles.

5. The DFL system of claim 4, wherein the training group of OEM vehicles include OEM vehicles that have previously had at least a certain number of previous V2V communication interactions and model weight exchanges with other OEM vehicles.

6. The DFL system of claim 4, wherein the second OEM vehicle and the control system are each further configured to, after the handshake procedure, exchange losses of the model, using the first and second pluralities of weights, and using both the local dataset and another local dataset at the second OEM vehicle, and reporting a consensus of the first and second pluralities of weights corresponding to a lowest model loss.

7. The DFL system of claim 1, wherein the model has been trained using an independent and identically distributed (IID) dataset, wherein the IID dataset is obtained from autoencoders trained per an architecture of the vehicle architecture in a federated manner to provide a latent space.

8. The DFL system of claim 1, wherein the model is configured to estimate a battery system state or health of the first OEM vehicle.

9. The DFL system of claim 1, wherein the model is configured to estimate a train parameter of the first OEM vehicle.

10. The DFL system of claim 1, wherein the model and its output are utilized by an autonomous or advanced driver assistance (ADAS) system of the first OEM vehicle.

11. A distributed federated learning (DFL) method for a model of original equipment manufacturer (OEM) vehicles including at least first and second OEM vehicles, the DFL method comprising:
accessing, by a control system of the first OEM vehicle and from a memory of the first OEM vehicle, the model, wherein the model is a machine-learning type model having a first plurality of weights associated therewith and is configured to generate an output based on a set of one or more inputs;
establishing, by the control system and via a transceiver of the first OEM vehicle and one of a set of communication networks, a vehicle-to-vehicle (V2V) connection with the second OEM;
exchanging, by the control system and the second OEM vehicle via the V2V connection, pluralities of weights for the model, including transmitting the first plurality of weights to and receiving a second plurality of weights from the second OEM vehicle;
executing, by the control system and using a local dataset, the model using both the first and second pluralities of weights to obtain two model outputs;
calculating, by the control system, a distance metric between the two model outputs; and
based on the calculated distance metric and a distance threshold, determining, by the control system, a consensus of the first and second pluralities of weights to be used by the model in both the first and second OEM vehicles.

12. The DFL method of claim 11, further comprising performing, by the control system, a threshold learning process to learn the distance threshold, wherein the threshold learning process involves the control system repeatedly receiving other pluralities of weights from other OEM vehicles, executing the model using the first plurality of weights and the other pluralities of weights to obtain respective pairs of model outputs, and calculating the distance metrics between each pair of model outputs.

13. The DFL method of claim 12, wherein the distance threshold is determined as a solution to the secretary problem.

14. The DFL method of claim 12, further comprising, after the threshold learning process is complete, performing, by the control system, a handshake procedure with the second OEM vehicle, wherein the handshake procedure involves a symmetric key exchange with an encryption scheme such that only accepted vehicles to a training group of OEM vehicles.

15. The DFL method of claim 14, wherein the training group of OEM vehicles include OEM vehicles that have previously had at least a certain number of previous V2V communication interactions and model weight exchanges with other OEM vehicles.

16. The DFL method of claim 14, further comprising, after the handshake procedure, exchanging, by the control system and the second OEM vehicle via the V2V connection, losses of the model, using the first and second pluralities of weights, and using both the local dataset and another local dataset at the second OEM vehicle, and reporting a consensus of the first and second pluralities of weights corresponding to a lowest model loss.

17. The DFL method of claim 11, wherein the model has been trained using an independent and identically distributed (IID) dataset, wherein the IID dataset is obtained from autoencoders trained per an architecture of the vehicle architecture in a federated manner to provide a latent space.

18. The DFL method of claim 11, wherein the model is configured to estimate a battery system state or health parameter of the first OEM vehicle.

19. The DFL method of claim 11, wherein the model is configured to estimate a train parameter of the first OEM vehicle.

20. The DFL method of claim 11, wherein the model and its output are utilized by an autonomous or advanced driver assistance (ADAS) system of the first OEM vehicle.
